(19) United States
(12) Patent Application Publication
(10) Pub. No.: US 2004/0135326 A1
(43) Pub. Date: Jul. 15, 2004

(54) Device for facilitating driving a rollable walker and a rollable walker provided with such a device

(76) Inventors: Goran Palmers, Askim (SE); Bengt Kron, Trollhattan (SE)

Correspondence Address: Matthew E. Connors, Gauthier & Connors LLP, Suite 3300, 225 Franklin Street, Boston, MA, 02110, US

(21) Appl. No.: 10/656,996

(22) Filed: Sep. 5, 2003

Related U.S. Application Data
(63) Continuation of application No. PCT/SE02/00366, filed on Mar. 1, 2002.

(30) Foreign Application Priority Data
Mar. 9, 2001 (SE) 0100845-7

(51) Int. Cl. B62B 5/02

(52) U.S. Cl. 280/5.2

(57) ABSTRACT

The present invention refers to a device for facilitating driving a rollable walker of the type incorporating a chassis frame, which is supported by at least one front wheel fitted to the depending frame part and a rear pair of wheels, which device incorporates a movable support attachable to the rollable walker in the area of its forward castor wheels and means adapted to move said movable support in front of said forward castor wheels when it/they are projecting backwards, at lifting of the said front castor wheels about the rear pair of wheels. The invention furthermore incorporates a rollable walker equipped with such a device.

The present invention refers to a device for facilitating driving of a rollable walker of the type incorporating a chassis frame, which is supported by at least one front wheel, fitted to a depending frame part and a rear pair of wheels. The invention also refers to a rollable walker equipped with such a device.

When using rollable walkers is it difficult for disabled persons to pass over obstacles such as door sills and kerb stones.

This is due to the fact that the wheels have small diameters and that the handles are situated at a high level. When the rollable walker is pushed in the forward direction, the forward force will attack at the handles, which are situated at a comparatively high level and it is therefore required a large force to push up the front wheels of the rollable walker above the obstacle or the system might be self-braking if it is a steep obstacle. If it hereby is tried to push the rollable walker forward against the obstacle, using a high force it is possible that the rear end of the rollable walker might raise resulting in that the rollable walker will turn over in the forward direction.

It is often difficult to persons using rollable walker to pass over or up on door sills, kerb stones and similar smaller obstacles, as it is heavy, troublesome and means a temporary instability to lift the forward end of the rollable walker at the same time as the rollable walker is pushed forward, thus that the front wheel or wheels are pushed in over the obstacle.

Therefore the purpose of the present invention now is to offer a device and a rollable walker of the type described, respectively, which is equipped with such a device, which is designed and equipped, respectively, with means adapted to permit in a simple and functional manner that the rollable walker can be easily moved up such level differences, which is for instance represented by a kerb stone and this has been achieved in that the device and the rollable walker respectively, have been given the features defined in the characterizing part of claim 1 and claim 18 respectively.

The invention describes two manners for circumventing the problem with passing low and high obstacles.

The device according to the invention can be manufactured as a separate asseccory or as part integral with the rollable walker.

For low obstacles such as door sills it is sufficient if the diameter of the front wheel is increased. As it is not practical to drive around with very big front wheels the big wheels have been replaced by a segment of a big wheel. The length of this segment shall assist the ordinary front wheels to get on top of the low obstacle.

Two different types of the segment are described in accordance with the invention.

One of the segments is constituted by a spoke having a track, which has a much bigger radius (e.g. 320 mm) than the ordinary front wheels of the rollable walker (e.g. 80 mm). The other segment is constituted by a curved trolley (referred to as inline) having recessed wheels. The trolley is attached to the rollable walker via a retainer with wheels (4 wheels), which follow the radius of the trolley. The radius of the curvature of the trolley can be made very large (e.g. 350 mm) without requirement for much space. The bigger the radius of curvature is made, the easier is it for the wheels of the trolley to get over the obstacle. The drawback is that the bigger radius for managing a certain height of the obstacle, the longer trolley is required. When using these solutions the rollable walker is driven over the obstacle without any action from the user. When the segment which is in its initial position, hits the obstacle, the track/the trolley will move over the obstacle and lift the front wheels of the rollable walker. When the front wheels are on top of the obstacle the track/trolley is relieved and moves back to initial position.

For high obstacles (e.g. kerb stones) the length of the segments is not sufficient for reaching above the obstacles. Then is utilized another function, which has three different principles. On one hand the two guides, on the other hand a function turning around the front wheel(s).

When using the invention at high obstacles the following will happen.

1. The user drives the rollable walker up to the obstacle until there is a stop.

2. The user applies the brakes of the rear wheels.

3. The user pulls the handles rearwards, whereby the front part of the rollable walker is raised.

4. The segment of the wheels pivot in over the obstacle.

5. The user pushes the handles in forward direction and the guide/wheels are brought down on top of the obstacle.

6. The user releases the brakes and drives in forward direction, whereby the guides move backwards or the wheel pivots backwards.

7. When the front wheels is on top of the obstacle the guides are relieved and return to their initial position.

8. When the rear wheels reach the obstacle it is easy for the user to get these up on the obstacle by pushing and at the same time lifting the handles.

Selection of function high/low obstacle.

At both solutions with segments it is possible to choose at which level the device shall change between the function for high and low obstacle. This is selected before the rollable walker is used and it then operates automatically.

For the inline solution the limit is determined by the curvature of the guide, the length of the guide and its ground clearance. Also the inline solution can be equipped with a level yoke if it is desired that the user shall be able to adjust the limit between high and low obstacle.

For the yoke solution there is a level yoke the forward edge of which decides where the limit between high and low obstacle is positioned.

The function of the level arm is that it is positioned below the yoke and hits the obstacle before the yoke reaches it. The arm then will move the yoke backwards thus that the high function can be used. When the yoke is moved backwards the arm itself will be pivoted upwards in relation to the yoke. In order to minimize the required lifting distance when the front end of the rollable walker is raised, there is a function preventing that the arm moves downwards relative to the yoke when the front end of the rollable walker is raised. This function can either be a coupling between the lowermost position of the arm and the distance the yoke is pushed in or a catch preventing the arm from moving downwards when the yoke is in pushed in position.

Hereinafter the invention will be further described with reference to a number of embodiments schematically illustrated in the accompanying drawings.

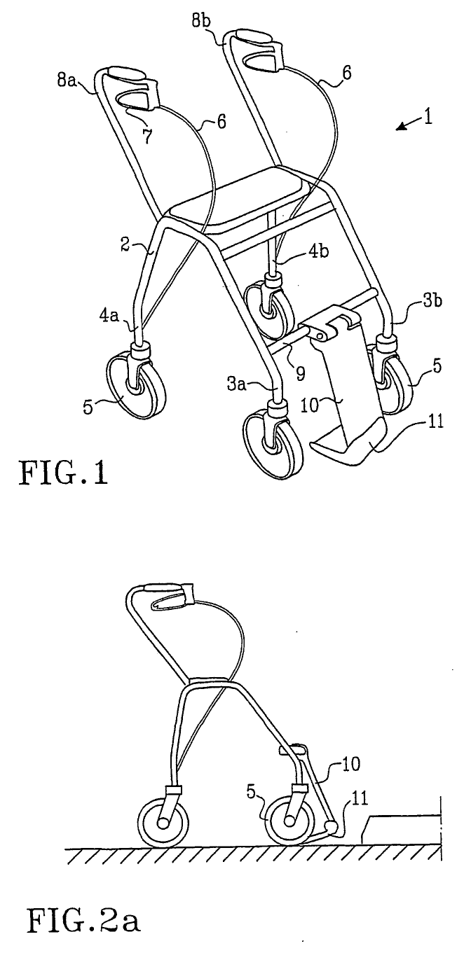

FIG. 1 shows schematically an embodiment of a rollable walker according to the invention as seen in perspective.

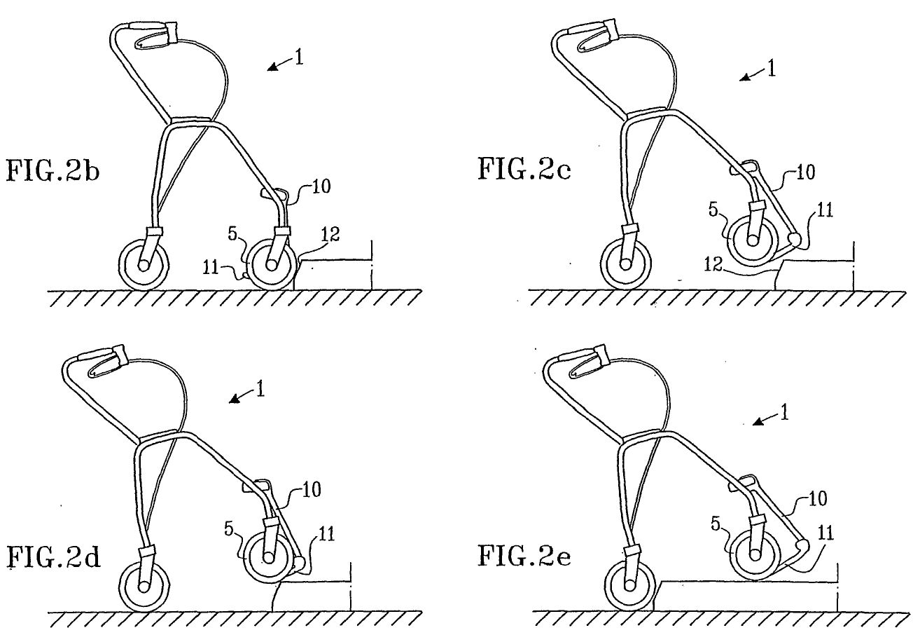

FIGS. 2a-2e show in side view the function of the rollable walker according to FIG. 1, when driving up on a kerb stone (high obstacle).

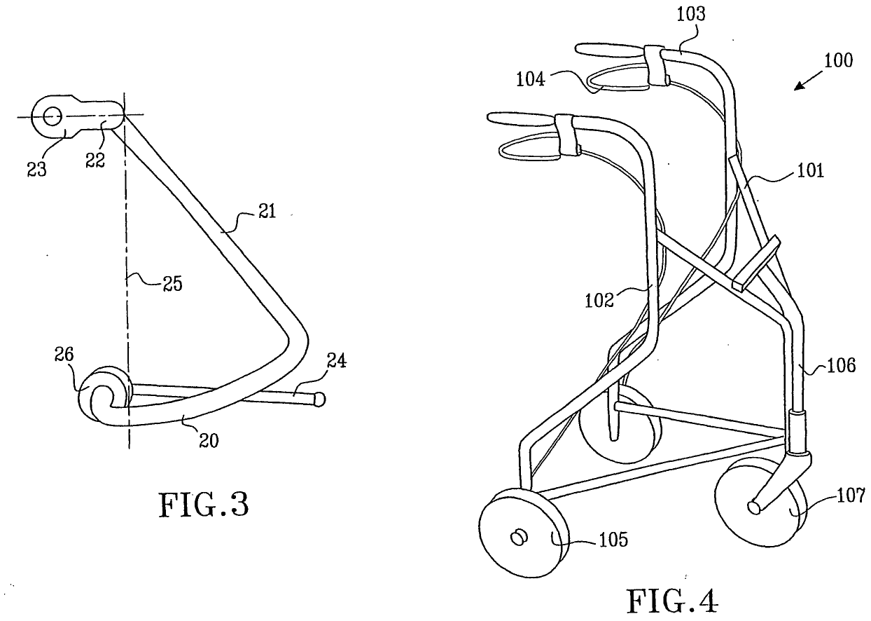

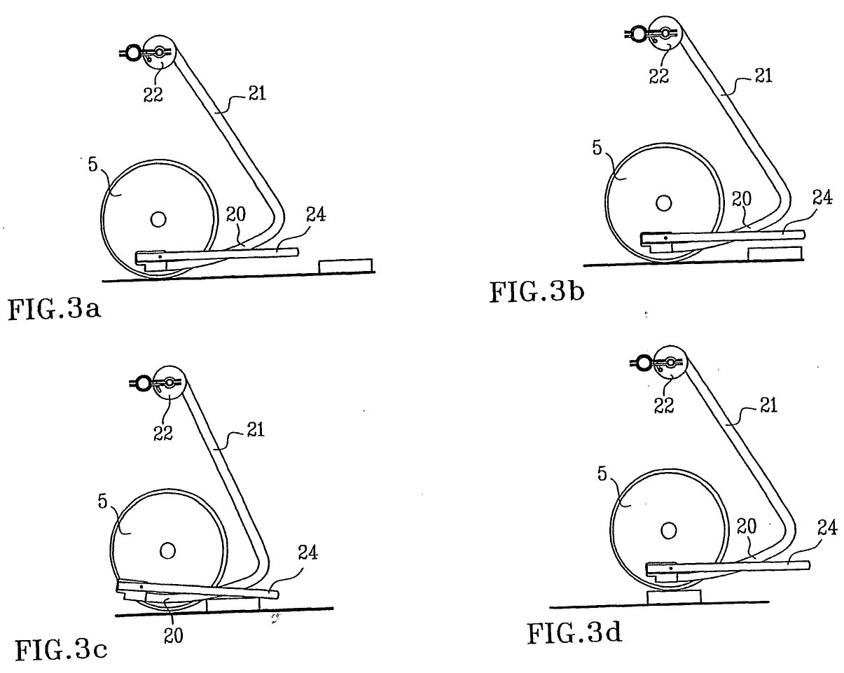

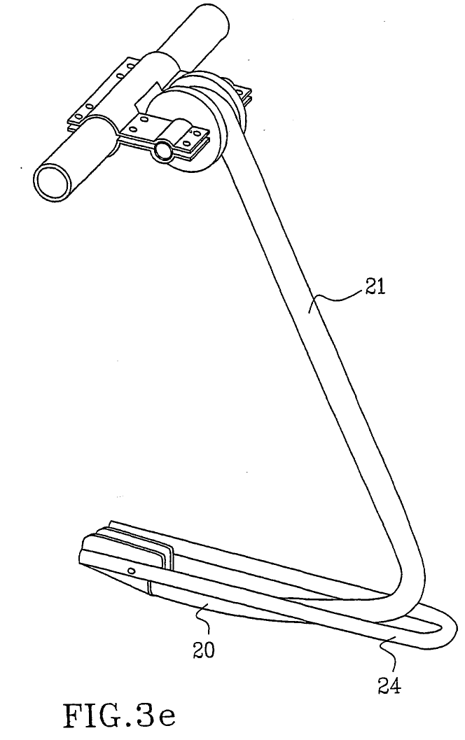

FIG. 3 illustrates schematically the function of a device of the type illustrated in FIG. 1.

FIGS. 3a-3d are views corresponding to FIGS. 2a-2e of the embodiment, which is schematically shown in FIG. 3, but at passage of a low obstacle.

FIG. 3e illustrates in perspective and schematically a device according to FIGS. 3a-3d, but shown without wheels.

FIG. 4 shows in another embodiment schematically and in perspective a three-wheel rollable walker according to the invention.

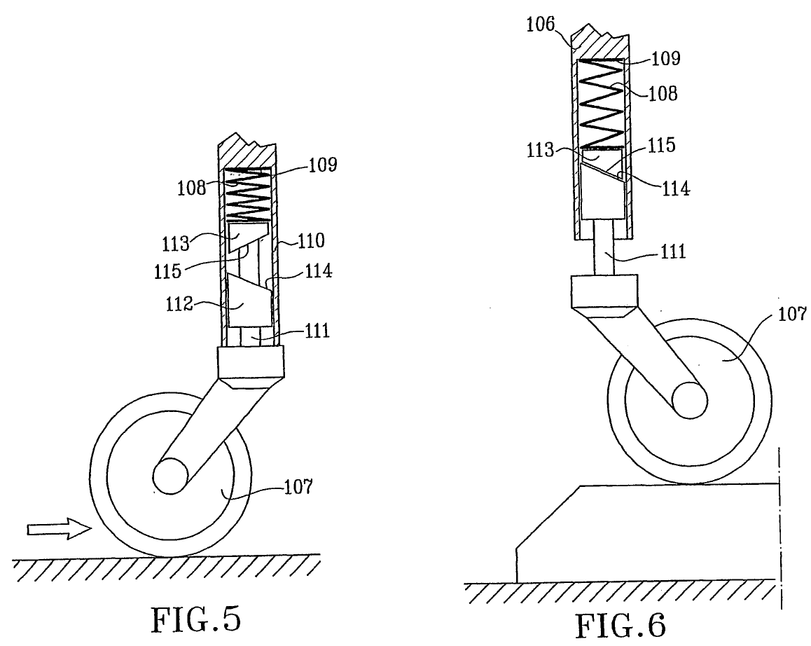

FIG. 5 is a partial view of a portion of the rollable walker according to FIG. 3, having a front wheel in driving position.

FIG. 6 shows a view corresponding to FIG. 5 with the front wheel in raised position.

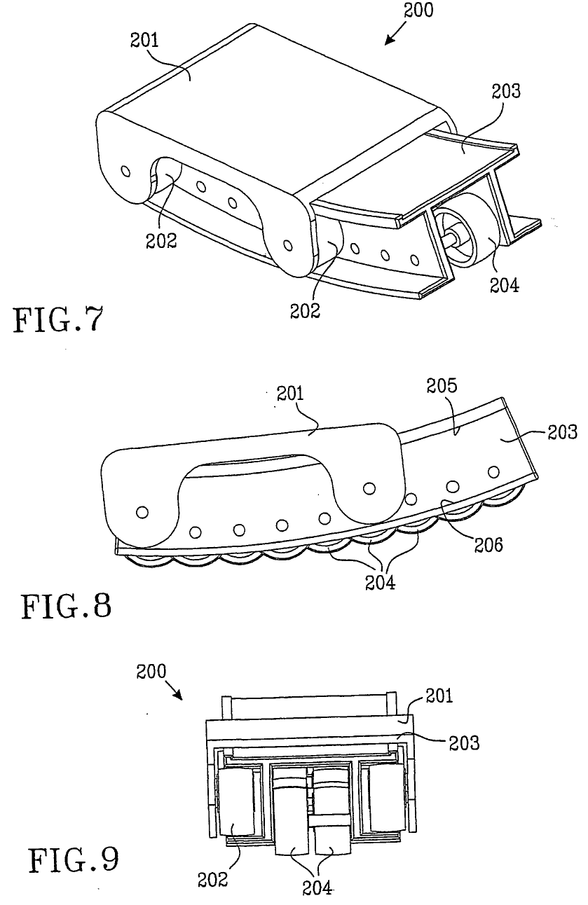

FIG. 7 shows in a schematical perspective view a further embodiment of an auxiliary component for driving over kerb stones and the like.

FIG. 8 is a side view of the auxiliary component according to FIG. 7.

FIG. 9 shows the auxiliary component according to FIGS. 7 and 8 in an end view from the front side.

FIG. 1 shows in perspective a rollable walker 1 equipped with a segment in the form of a portion of a wheel. The wheel incorporates a hub, a spoke and a track and the rollable walker incorporates furthermore an upright frame 2 with two front legs 3a, 3b and two rear legs 4a, 4b, respectively, each of which supports a castor wheel 5. The rear castor wheels are braked by means of not further shown conventional brakes, which are actuated via brake wires 6, which are connected to brake handles 7, attached to two driving handles 8a, 8b, ascending from the frame just about at the rear legs 4a, 4b. Between the front legs 3a, 3b is provided at a distance above the wheels 5 a transversal frame portion 9 interconnecting the legs 3a, 3b. This transversal frame portion 9 supports, in the embodiment shown, a rail 10 which is pivotably supported at the transversal frame portion 9, which rail constitutes said spoke, which carries a support 11 fixedly connected to the outer end of the spoke, and which represents said track, and which in the embodiment shown is constituted by a rearwardly angled plate, which in its neutral position is situated in front of the front wheels 5 and preferably has an end portion projecting in between these wheels.

The rail 10 is spring biased, preferably at its journalling point about the frame part 9, thus that it tends to project in front of the front wheels 5, such as shown, e.g. in FIG. 2a, which shows the rollable walker 1 from the side adjacent a kerb stone 12.

In FIG. 2b is illustrated how the rollable walker 1 has been driven up against the (high obstacle) kerb stone 12, whereby the rail 10, against the action of the spring preload has been swung to a position, where the rail and the support fitted thereto are situated completely pushed in between the front wheels 5.

In this position the user of the rollable walker 1 can apply the brakes at the rear wheels 5, and at the same time by means of the handles 8a, 8b pivot the front wheels 5 up over the kerb stone 12, whereby, as illustrated in FIG. 2c, the rail 10 due to its spring preload is again moved forward to its position in front of the front wheels 5, where its support 11 is positioned above the kerb stone and extends a distance in over the kerb stone.

When the support 11 is situated in this position (FIG. 2c) it is possible to advance the rollable walker 1 after the brakes have been disengaged, up above and along the upper side of the kerb stone, such as shown in FIGS. 2d and 2e. In the position shown in FIG. 2e the rear pair of wheels 5 of the rollable walker may easily be pivoted upwards thus that the entire rollable walker is situated on the upper side of the kerb stone or the like.

In this manner, it has with simple means been created a rollable walker of conventional design equipped with an accessory which is simple both structurally and functionally and by aid of which the problem with moving the rollable walker over kerb stones, door sills or the like has been eliminated to a large extent without giving the rollable walker more operational means, which make the handling of the rollable walker more difficult for the user.

In FIG. 3 is shown schematically an accessory of the type in question, which illustrates the principle of the embodiment according to FIGS. 1 and 2, and which is designed as a curved yoke, which forms a segment 20 of a track of an imagined wheel having a spoke 21 with a bigger and preferably much bigger radius than the front castor wheel of a rollable walker on which the accessory shall be mounted. This spoke 21 is rotatably mounted about a hub 22, which directly or via a bracket 23 is attachable to the frame of a rollable walker, thus that the curved yoke is situated between the front wheels of the rollable walker.

For driving over low obstacles, such as door sills it should be sufficient to provide the rollable walker with wheels of a larger diameter, but on the other hand it is unpractical to drive with very big front wheels and for that reason such big wheels have been replaced by the yoke-shaped wheel segment according to FIG. 3. Due to the length of the segment the ordinary front wheels of the rollable walker will reach up on the low obstacle.

FIG. 3 shows schematically an embodiment of an accessory, which makes it possible for the accessory, by means of an adjustment, to be caused to consider the obstacle as high or low. This is effected in that the level of the front portion of the level yoke 24 is adjusted. If the obstacle is lower than the front portion, then the obstacle is considered to be low.

FIG. 3a shows schematically the rollable walker advancing a low obstacle. During the entire sequence the user pushes the rollable walker in forward direction without stopping or making any manipulations.

FIG. 3b shows the position when the obstacle is engaged by the track of the yoke. From this position the track will take over the function of the forward wheel and raises the front end of the rollable walker. Then the yoke will move backwards relative to the rollable walker, as if it was a wheel of big diameter.

FIG. 3c shows the position when the ordinary front castor wheel engages the obstacle. The ordinary front wheel then will resume the function as a front support, whereby the yoke is relieved from load.

FIG. 3d shows the wheel on top of the obstacle when the yoke has resumed its ordinary forward position.

In the embodiment with the yoke according to FIG. 3 there is preferably a level arm 24 connected to the yoke, which arm is adjustable thus that its front edge can take up different levels above the base, and which therefore determines at which level of an obstacle, the yoke shall serve for letting the front wheels of the rollable walker reach above the obstacle or for making the yoke be moved backwards under increasing tension in order thereupon to bridge the obstacle when the front end of the rollable walker is raised in the manner described hereinbefore. When the yoke is moved backwards the level arm will be pivoted upwards in relation to the yoke. For minimizing the required lifting height when the front end of the rollable walker is raised there are means preventing the level arm from moving downwards relative to the yoke when the front end of the rollable walker is raised. Theses means may either be a coupling between the lowest position of the level arm and the pushing in of the yoke, or a catch, which prevents the level arm from moving downwards when the yoke is in its pushed in position. These means are illustrated in FIG. 3 as a schematical coupling 25 and a catch 26 shown in a dash-and-dot fashion.

FIG. 3e shows in perspective the segment 20 with its spoke 21 attached to the hub and the level yoke 24 and as can be seen here, the level yoke is preferably designed as a U-formed arm, the U-shanks of which extend on opposite sides of the segment 20 and has ends of the U-shanks articulatedly attached to a retainer at the end of the segment facing backwards.

In FIG. 4 is shown in perspective an alternative embodiment according to the present invention applied at another type of rollable walker than that shown in FIG. 1. This rollable walker 100 is equipped with a frame 101 having two rearward frame portions 102 with a substantially vertical extension and each one of which at the upper part is shaped as a handle 103 with a brake handle 104 and which at its lower end supports a wheel 105 equipped with, not further shown brake components. To these frame portions 102 attach a forward oriented, third frame portion 106 which is substantially vertical, and which is situated in front of the rearward frame portions and which at the lower side supports an articulatedly supported castor wheel 107, the design and function of which will be further described with reference to FIGS. 5 and 6.

FIG. 5 shows a schematical cross section through a part of the third frame portion 106 with the wheel 107 at the embodiment according to FIG. 4. The lower part of the frame portion 106, as can be seen, is tubular and includes a spring 108, which engages a fixed bottom 109 of the tubular part 110. The castor wheel 107 is rigidly connected to a vertical shaft 111, which extends rotatably and axially movably through a fixed guide 112 provided in the tubular part and which ends with a widened head 113 between the guide 112 and the spring 108. On its side facing away from the wheel 107, the guide 112 is equipped with an oblique surface 114 sloping in the forward direction, and the widened head 113 of the vertical shaft 111 on its end facing the guide is also equipped with a surface 115 sloping to the same extent. The dimensions of the tubular part, the vertical shaft 111, the spring 108 and the positioning of the guide 112 and the strength of the spring are such, that, when the rollable walker is driven in normal manner on a smooth base, the contact pressure between the base and the castor wheel 107, as shown, will compress the spring 108 between the fixed bottom 109 and the upper part of the widened head 113 of the vertical shaft 11, thus that the sloping surfaces 114 on the guide 112 and 115 on the widened head 113 on the shaft 111 are separated. During rolling the front wheel 107, which is designed as a castor wheel, therefore will adjust itself with the angled part of the sleeving arm facing backwards.

Turning of the castor wheel is achieved both from the spring force and from the influence of gravity on the wheel.

When the front castor wheel is raised such as shown in FIG. 6, preferably in that the rollable walker in braked position is tilted backwards about the rear, fixed wheels 105, the spring 108 will urge the vertical shaft 111 downwards, whereby the sloping surface 115 on the widened head 113 will contact the fixed, sloping surface 114 of the guide 112, whereby the force of the spring 108 will pivot the shaft 111 of the castor wheel 107, which is rotatable in the guide, thus that the castor wheel is turned in forward direction, such as illustrated in FIG. 6. In this position the castor wheel thus is pointing in the forward direction and can be moved in over, e.g. a kerb stone or another obstacle in that the brakes are released, i.e. the user releases the brake handles.

In FIGS. 7 to 9 is shown an alternative embodiment of an accessory 200 applicable to a rollable walker of the type in question, and which in the same manner as the embodiments earlier shown and described is moved forward over an obstacle situated ahead of it when the front end is raised.

This embodiment is particularly appropriate in cases where a low constructional height is desired.

In FIG. 7 is shown in perspective the accessory 200 according to the invention, and which incorporates a retainer 201, which with a (not shown) fitting is attachable to the lower side of a rollable walker in connection to the front wheel of the rollable walker, and preferably between two front wheels. The retainer 201 is positioned thus that the ground wheels of the trolley have their lowermost point above the contact point of the front wheels against the base, when the front wheels are in the rearward angled position and it is mainly tray-shaped and has in the embodiment shown, one wheel 202 adjacent each one of its corners. These wheels 202 act as guide wheels for a trolley 203, provided with a number of ground wheels 204, intended to roll against the base. The trolley 203 thus is movably supported on the guide wheels 202 of the retainer and it is preloaded by means of a (not further shown) spring arrangement, thus that it in normal, uninfluenced driving position, is situated in a forward end position, such as shown in FIG. 8, where it projects in front of the front end of the retainer 201 and therefor in front of the front wheels of the (not shown) rollable walker. The trolley 203 is equipped with curved tracks 205, 206 for the guide wheels 202. The radius of curvature of these tracks is big, and can for instance be about 500 mm.

The retainer 201 is positioned and oriented thus that the ground wheels 204 of the trolley have their lowermost point at a level somewhat above the front wheels of the rollable walker at driving in forward direction on a substantially planar base.

As shown in FIG. 9 the ground wheels 204 are arranged in two rows and they are mutually displaced in the longitudinal direction, for avoiding that the wheels 204 are get stuck when driving over edges.

With a rollable walker equipped with an accessory 200 of this kind, at driving over a door sill, one of the ground wheels 204 will hit. Due to where the friction is at its minimum the trolley 203 will either move into the retainer 201 against the action of the spring preload, or the ground wheels will roll directly over the door sill.

If the trolley 203 with its front edge hits a kerb stone or a higher door sill, the trolley will be pushed backwards into the retainer 201 against the action of the spring preload. When the trolley has been pushed at least a little bit into the retainer and its front edge engages the kerb stone, its rear wheels are braked and the handles of the rollable walker are moved backwards thus that the front part is raised. Due to the spring preload, the trolley 203 is hereby pushed in forward direction and over the kerb stone and the rollable walker can be driven on at the higher level after a simple lifting of the rearmost wheels.

The invention is not limited to the embodiments shown and described in connection thereto but modifications and variants are possible within the scope of the following claims.

1. A device for facilitating driving of a rollable walker of the type incorporating a chassis frame, which is supported by at least one front wheel fitted to the depending frame part and a rear pair of wheels,
characterized therein, that the device incorporates a movable support (11; 20;107; 203) attachable to the rollable walker in the area of its forward castor wheels (5, 107) and spring-loaded means for moving said movable support (11; 20;107; 203) horizontally in front of said forward castor wheels when it/they are projecting backwards, when the said front castor wheels are raised by being pivoted about the rear pair of wheels.

2. A device for facilitating driving of a rollable walker of the type incorporating a chassis frame, which is supported by at least one front wheel fitted to the depending frame part and rear pair of wheels,
characterized therein, that the device incorporates a movable support (11; 20;107; 203) attachable to the rollable walker in the area of its forward castor wheels (5, 107) and having a weight means for moving by gravity said movable support (11; 20;107; 203) horizontally in front of said forward castor wheels when it/they are projecting backwards, when the said front castor wheels are raised by being pivoted about the rear pair of wheels.

3. A device as claimed in claim 1 or 2,
characterized therein, that the movable support is constituted by a member which in uninfluenced positions project in front of said front castor wheels, and is adapted to be pushed backwards by a contact force against an obstacle under an increased preload, and to be moved due to the preload in over the obstacle after lifting of the said front wheel above the obstacle.

4. A device as claimed in claim 3,
characterized therein, that the movable support is constituted by a yoke (11, 20) subjected to a spring load.

5. A device as claimed in claim 3 or 4,
characterized therein, that the yoke is a segment of a track (20) of a wheel, which via a spoke (21) is turnable about a hub (22) having a bigger radius than said castor wheel.

6. A device as claimed in claim 5,
characterized therein, that the track (20) is designed thus that it for smaller obstacles operates as a wheel having a bigger diameter than the ordinary front castor wheel.

7. A device as claimed in claim 4 or 5,
characterized therein, that the yoke is equipped with an adjustable level arm (24) arranged below the front portion of the yoke and adapted to hit an obstacle before the yoke (20) hits, when driving against an obstacle.

8. A device as claimed in claim 7,
characterized therein, that the level arm (24) is provided with means (25; 26), causing the arm to be freely movable downwards to its lowermost position when the yoke (20) is in a position of rest, and which arm is freely movable upwards when the yoke is caused to move backwards.

9. A device as claimed in claim 8,
characterized therein, that the level for the lowest position of the level arm (24) is adjustable.

10. A device as claimed in claim 1 or 2,
characterized therein, that the movable support is constituted by the front castor wheal (107) of the rollable walker, which is adapted to be rotated from its normal driving position to a position where it is projecting in forward direction above an obstacle, when said front wheels are raised.

11. A device as claimed in claim 9,
characterized therein, that the rotation of the castor wheel (107) from its normal driving position to a position projecting in the forward direction is effected by the geometrical design of the castor wheel.

12. A device as claimed in claim 9,
characterized therein, that the rotation of the castor wheel (107) from its normal driving position to a position projecting in the forward direction is effected by mechanical actuation.

13. A device as claimed in claim 1,
characterized therein, that the movable support is constituted by a track (201) for a wheel-equipped (202) curved trolley (203), adapted under spring influence to project from said track in the forward direction of the rollable walker, and to be preloaded at engagement against an obstacle ahead, for being pushed forward at subsequent raising of the front wheels of the rollable walker under influence of the spring preload, and thereby out above the obstacle.

14. A device as claimed in claim 13,
characterized therein, that the track (201) is designed thus that it operates as a wheel having bigger diameter than the ordinary front castor wheel for passage of low obstacles.

15. A device as claimed in claim 13,
characterized therein, that the trolley (203) is equipped with an adjustable level arm (24) provided under the forward part of the yoke and adapted when driving against an obstacle to hit this before the trolley (203).

16. A device as claimed in claim 15,
characterized therein, that the level arm is equipped with means, making the arm freely movable downwards to its lowest position when the yoke is in a rest position, and freely movable upwards when the yoke is brought backwards.

17. A device as claimed in claim 16,
characterized therein, that the level for the lowest position of the level arm (24) is adjustable.

18. A rollable walker of the type incorporating a chassis frame, which is supported by at least one front wheel fitted to the depending frame part and a rear pair of wheels,
characterized therein, that the rollable walker in the area of its forward wheels is provided with a movable support and means adapted to move said movable support in front of said forward castor wheels when it/they are projecting backwards, in accordance with anyone of claims 3-17.
